(19) United States
(12) Patent Application Publication
(10) Pub. No.: US 2006/0020541 A1
(43) Pub. Date: Jan. 26, 2006

(54) System and method for automated title searching and reporting, reporting of document recordation, and billing

(76) Inventor: Chris Gommlich, E. Northport, NY (US)

Correspondence Address: Mitchell A. Stein, Esq.;STEIN LAW, P.C., Suite 4, 24 Woodbine Avenue, Northport, NY, 11768, US

(21) Appl. No.: 10/894,665

(22) Filed: Jul. 20, 2004

(51) Int. Cl. G06Q 40/00

(52) U.S. Cl. 705/40

(57) ABSTRACT

A method and system for automated title searching and reporting, having one or more generally geographically located computers each having software and one or more databases; an interface for receiving instructions from one or more clients setting forth desired title information for one or more pieces of property such that the interface determines which of said computers to which to send the received instructions and communicates those instructions; searching and gathering data concerning the desired title information from a multiplicity of locations including regional records (from county clerk(s)), an intranet or the Internet; each of the computers via its software, presenting one or more screens for interpolation of data concerning said desired title information; interpolating the data into one or more screens; storing the interpolated data on one of the database(s); and transmitting the interpolated data to the proper client. Additionally, the method and system provides for logging each of its uses, archiving the data, providing access to the archived data by the proper client, reporting the recordation of documents relating to title information, management of all the data and billing the proper client and/or examiner (or user) for the use of the method and system in the manner proscribed, and facsimile transmission either by way of fax software or by hard copy.

### FIELD OF THE INVENTION

The present invention relates to the field of title searching and reporting, and more particularly to a method and system for automated delivery and receipt of instructions and provision to clients of reliable, authentic, title-related data and results in an automated, efficient, rapid and cost-effective manner, utilizing a multiplicity of virtually simultaneous computer-based title search engines interfaced to trained searchers having access to reliable and authentic title-based public information interpolated via the search engine(s) into rapidly produced reports generated and returned to a plurality of clients.

### BACKGROUND OF THE INVENTION

Critical to every real estate transaction is valid, reliable, and expeditious information concerning title to the real property involved in the transaction. Such information includes liens, encumbrances, and any other item of information relating to the property and/or owners of the property necessary for any funding source, whether institutional (e.g., banking) or private source, to evaluate the risks involved and make a determination to fund or not, and if to fund, to evaluate the risks and determine the terms of the transactions. While obviously a credit report on the individuals or entities involved is important to the transaction, one could easily contend that the most important element, indeed, the hardest working component that virtually “guarantees” the validity and completion of the transaction, is the title report.

Underlying the title report is the obtainment and provision of relevant, authentic and reliable information concerning the property in issue. Traditionally, such title work is performed in an antiquated way, where a title searcher with local access to a local town clerk is requested by way of a paper order, transmitted at times orally or by facsimile, with hand-written or typed information giving information (generally name and address) and asked to provide a complete title search back to the requester on or before a certain date (or as soon as possible). Often the request is given by institutional lenders, at times by lawyers, and often by title insurance companies. The title searcher travels to the county or town clerk and searches public records maintained by hand, or, at times, by computer, microfilm, microfiche, etc. Unless and until such information is actually scanned and rendered available in reliable form, the title searcher will review and compile from actual, physical paper. Indeed, with the ability to modify scanned (or otherwise computer-generated) images, there may never be a complete replacement for paper records.

With low interest rates, refinancing ability, and new purchases and repurchases on the rise, competition among financiers as well as title searchers who gather the information, and those who review and provide reports, has grown. Thus, the speed and reliability of the search, obtainment, provision, review and approval (or disapproval) process, triggers the timing from contract to closing, and becomes of ever pressing concern. The quicker the process, the more likely the closing, and the greater the revenue to all involved in the process. As a result, the antiquated mechanical system of a person searching records, physically making copies, physically hand writing or typing reports on a typewriter, and providing the same is time consuming, and becomes a weak link and slow-down in the process, potentially risking the ability of a lender to successfully outperform competitors and “close” the deal.

Additionally, while the world of the Internet has grown and computers have become household commodities, the vast majority of records, especially those relating to real property, are still maintained in hard copy paper format. As a result, the searcher, armed with a myriad of property identifiers including, e.g., section, block and lot number, who travels to the local clerk, must look through paper sources (and, at times, computer records, microfilm, microfiche and the like), review liens, mortgage documents, potentially see anomalies and either ignore them or track them down (like misspellings or other names on titles, surrogate proceedings, co- or joint ownerships and the like), review the vast amount of paper, make copies, and somehow reduce the entirety to a paper report which can then be compiled and transmitted (by courier or other means) to the lender or other requestor of the information for analysis and determination. It is one object of the invention to provide computer-based results thereby eliminating the normal courier transmission mechanism and hence minimize the turn-around time.

Moreover, while certain information has been rendered by certain counties or towns in certain states to be available by way of the Internet, it is readily understood that such files, typically stored in Adobe (®) format (*.pdf) can be modified in any number of ways by a plethora of programs, thereby rendering such information inherently unreliable and potentially not authentic. Moreover, when one sees the document, anomalies that may require searching in other locations (like surrogates records, for example) are generally unavailable, and hence, the mere presence of some of such information on the Internet is insufficient for the needs of client customers and the provision of reliable, authentic and complete information. The instant invention overcomes the illusion that all data is authentic and available via the Internet, and its adaptability of the fields for data entry to the myriad of local geographical clerks offices, a heretofore unknown advantage.

The interface between the computer and the title searching process has simply heretofore not been accomplished, perhaps because of the complexity of the process, or simply as a result of the absence of computer sophistication of the searcher. Regardless of the reason, the result is an utter absence of a complete method and system for providing title search information and reporting in an expeditious, accurate and authentic manner, in which a computer-generated typed report is computer driven to the client from reliable information directly obtained by the searcher utilizing the inventive system and method.

Some automated systems have been sought for development, but have largely failed to satisfy the industry's needs. For example, datatree.com provides an interface to public records for data retrieval, but little more. While one can see some public records (but not all), there is no assurance that the records are complete or reliable, and if anomalies appear, no ability for the system to provide further information (as in, for example, surrogate proceedings, explaining changes in ownership and the like).

Likewise, dataquick.com, bridgespan.com, and etitlesearch.com are available, but generally do not provide sufficient information, and, rather, become viable candidates more as clients than as real title search assistance.

U.S. Pat. No. 6,321,202 shows a system and method for managing transactions relating to real estate, with little reference to performing title searches, but rather maintaining information and tracking for real estate transactions. Electronic communication and storage of information, in general, is shown in U.S. Pat. No. 5,734,823.

It is thus an object of the instant invention to provide a method and system for the receipt of one or more requests from one or more clients for title searches to an interface, communication of such title searches to regional title search engines, collection of accurate and authentic local information, reporting back in scanned and hard copy format, with backups, and transmittal of information in either facsimile or other format to the client in an efficient, rapid and organized manner, with the additional ability to bill clients and report document recordings in a method similar to title searches.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a method and system for automated title searching and reporting, having one or more generally geographically located computers each having software and one or more databases. In this regard it should be recognized that data is regionally stored, so that if a search is performed in, for example, Arkansas, the information may be readily available at a county clerk's office in hard copy, whereas in other locations some or all of the information is provided by a clerk's office on an intranet for printing, and still in others via the Internet requiring no travel to the specific location.

Further included is an interface that is basically the “brain” of the operation, for it receives instructions from one or more clients setting forth desired title information for one or more pieces of property, determines which of the computer systems to which to send the request, monitors (by polling each computer if available, or otherwise) the status of the request, receives the responses or otherwise accesses the same by way of one or more databases, manages the billing operations as well as payments to, or license fees from each user of the computer, as well as billing the customer that solicits the information, and otherwise fully supervises the operation.

Additionally, the method and system provides for logging each of its uses, archiving the data, providing access to the archived data by the proper client, reporting the recordation of documents relating to title information, management of all the data and billing the proper client (whether examiner and/or recipient of the information) for the use of the method and system in the manner proscribed, and facsimile transmission either by way of fax software or by hard copy.

The features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is a general system overview of a preferred embodiment of the invention showing the fundamental components in flow format;

FIG. 2 is a portional view of an additional embodiment wherein a multiplicity of requests are received by an interface portion through the Internet and transmitted to regionalized search engines in accordance with the subject invention;

FIG. 3 is a general flow overview from client request to result communication to the client in accordance with the subject invention;

FIG. 4 is a screen capture of a new order layout for fields for completion when an order is received for a title search, in accordance with the preferred embodiment of the subject invention;

FIG. 5 is a screen capture of the fields of a generalized overview of a completed search layout, showing general fields of information gathered to be provided to the client, in accordance with the preferred embodiment of the subject invention and subject to modification and alteration specific to the geographical location in issue;

FIG. 6 is a screen capture of the fields of a deed information for a completed search, in accordance with the preferred embodiment of the subject invention;

FIG. 7 is a screen capture of the fields associated with mortgage information for a completed search, in accordance with the preferred embodiment of the subject invention;

FIG. 8 is a screen capture of the fields associated with purchase money mortgage data, in accordance with the preferred embodiment of the subject invention;

FIG. 9 is a screen capture of the fields associated with town tax data, in accordance with the preferred embodiment of the subject invention;

FIG. 10 is a screen capture of the fields associated with school tax data, in accordance with the preferred embodiment of the subject invention;

FIG. 11 is a screen capture of the fields associated with judgment data, in accordance with the preferred embodiment of the subject invention;

FIG. 12 is a screen capture of the fields associated with federal tax lien data, in accordance with the preferred embodiment of the subject invention;

FIG. 13 is a screen capture of the fields associated with mechanics lien data, in accordance with the preferred embodiment of the subject invention;

FIG. 14 is a screen capture of the fields associated with lis pendens data, in accordance with the preferred embodiment of the subject invention;

FIG. 15 is a screen capture of the fields associated with UCC lien data, in accordance with the preferred embodiment of the subject invention;

FIG. 16 is a screen capture of the fields associated with surrogate information, in accordance with the preferred embodiment of the subject invention; and

FIG. 17 is a screen capture of the fields associated with heirs or next of kin data in relation to the surrogate information fields set forth in FIG. 16, in accordance with the preferred embodiment of the subject invention.

### DETAILED DESCRIPTION OF THE PREFERRED EMBODIMENTS

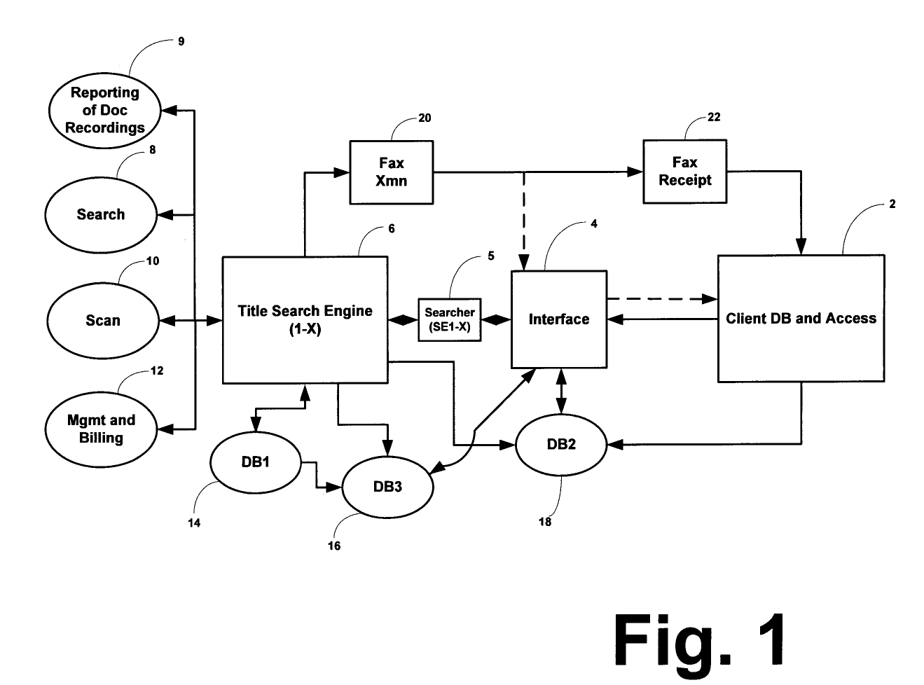

In accordance with the subject invention, and with particular reference to FIG. 1, an overall system view is shown, wherein one or more clients (T1-TX), referred to as item 2, having a database (“DB”) and access to the system are provided the opportunity to utilize the system, typically for a fee per service. It should be understood that such one or more clients can be a single large entity that performs many financings and hence requires a multiplicity of searches, as well as a single or multiple number of banks, title insurance companies, lending institutions, lawyers and the like all requiring expeditious title information.

Client DB and Access 2 interfaces with interface 4. Interface 4 is the essential major first step in the process, since information passes through interface 4 and is disbursed to title search engines (1-X) 6. In the currently preferred embodiment, search engines 6 are a plurality of users who have computers, typically a notebook or laptop (or even a PDA to the extent that it carries sufficient power to run the applications), and who utilize the computer and software provided therein, in accordance with the invention, to gather data, store the data, and provide for its eventual passage and return to the client DB 2.

In the preferred embodiment shown in FIG. 1, title search engine 6 provides the user, who is performing the search, with the ability to garner information (whether in hard copy from a county or other clerk or record room or via the Internet to the extent reliable data is available), input the data into various screens on the software contained in the engine 6. In this respect, the title searcher employing engine 6 performs search at step 8, scans relevant data at step 10, and utilizes management functions including billing contained in the software engine via step 12. In particular, the method and system of the current invention provides the searcher, utilizing engine 6, with the ability to either obtain hard copy paper, or to scan the same. Information, as explained in greater detail below in connection with the screen capture figures, gathers such information utilizing management functions 12 to create reports, e.g., fee schedules, billing payment history, client information, accounts receivables, etc.

Once the report is completed, and all the information gathered, two mechanisms are demonstrated for providing the information to client 2. In a currently preferred embodiment, searcher 5, via search engine 6, utilizes fax transmission via step 20 (either hard copy or directly through a computer fax program), with a copy transmitted to interface 4 (if required, hence the dotted line), and receives a fax receipt at step 22, indicating that the information has been transmitted to client DB2 for access. In an alternative embodiment, searcher 5 faxes or otherwise transmits the information to interface 4 which, in turn, transmits the information directly to client 2. It should be appreciated that client 2 receives information in a format that provides easy access for creation of the final search report and title insurance package, hence eliminating a step ordinarily labor intensive and typically provided by client 2, e.g., data entry. One of ordinary skill in the art will appreciate that once images are scanned in any format available and/or the fields are completed for the screens (as described in greater detail below), fax programs convert the output to a fax and via a telephone modem, Internet connection, wireless devices and the like, pass the fax information to client DB2. It should be appreciated that any one or more mechanisms known in the art can be utilized to pass this information to client 2 in any format deemed necessary, although hard copies are, at least currently, the preferred final outcome. Traditionally, the search report, prepared by the client after receipt at client DB2, is a paper document that contains a plurality of information, including deeds, mortgages, liens, and the like, which are eventually included with the terms of the title insurance thereafter provided if and when the real property transaction closes. Thus, in the currently preferred embodiment, provision is made for “hard copy” creation at the client end, although a non-paper based system is also contemplated by the invention and well within its spirit, intent and scope.

Title search engine 6 also contains DB1, item 14, which is a database directly linked to the search engine, with read/write capability, such that information can be input and modified by the user of search engine 6. Also connected, in this preferred embodiment, is an archival DB2, item 18, which is a backup of the final report, and which can be accessed via interface 4, as well as by client 2. Likewise, DB3, item 16, is provided as an archival database, as part of search engine 6, such that all information from DB1, item 14, is downloaded to DB3, item 16. DB3, item 16, can be accessed via interface 4. While one of ordinary skill in the art can modify the structure without deviation from the spirit, intent and scope of the subject invention, the purpose of having the redundant databases (items 14, 16 and 18) are multiple. For example, all activity of DB1, item 14, is logged in DB3, item 16. Since the billing model contemplates that the searcher pays a fee for use of the engine 6, each time the engine 6 is accessed or otherwise used for title searches, a record is maintained in an archival (write only) format on DB3, item 16. Thus, both the data from DB1, item 14, as well as the use of engine 6 are logged in DB3, item 16. In this manner, DB3, item 16, is primarily utilized to track usage of, and fees required for, the title search engine 6.

It should be appreciated that archival DB2, item 18, also permits access via client DB and access item 2. In this manner, if, for any reason, the client loses, misplaces, or otherwise needs or does not receive data, potentially for an additional fee, this information is maintained in DB2, item 18.

It should also be appreciated and understood that interface 4 can be used to poll each title search engine 1-X, item 6 to track usage and location. In this manner, feedback as to status of searches and location of searchers 5 can be obtained. Access to DB3 remotely also provides constant polling ability to provide interface 4 with determination of the status of searches as they are occurring, as well as control over billing. This provides virtual real time status of researches and results, heretofore unheard of in the industry.

Additionally, as shown in FIG. 1, the system further includes reporting of document recordings step 9. While the county clerk typically performs the function of actually recording documents, the system provides the searcher 5 with the ability to track the documents provided to the clerk for recordation and, more importantly, to report that the documents have been properly recorded and provide those facts and statuses through title search engine 6, and, accordingly, bill the client and/or the examiner who is using the search engine to provide the service to the client.

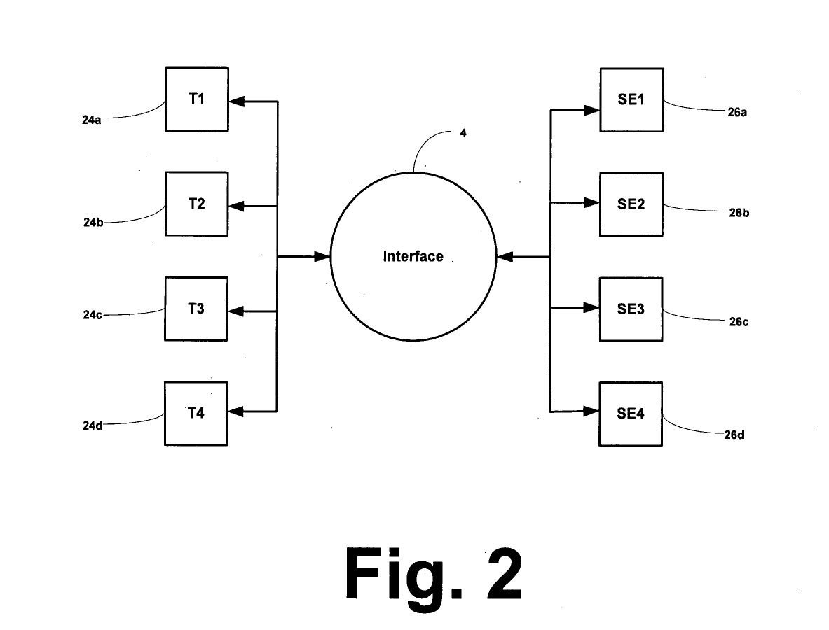

FIG. 2 shows an overall view of interface 4, wherein a multiplicity of clients T1, item 24a, T2, item 24b, T3, item 24c, and T4 item 24d, send search requests to interface 4, and interface 4, then disburses them to the geographically appropriate search engines, designated SE1 through SE4, items 26a through 26d. It should be appreciated that while four of each are shown, any number may be handled by interface 4, the invention comprising at least one request and at least one search engine, which inherently includes a plurality, in this instance, four being shown, but many more to the extent of physical hardware restrictions inherent in computer technology and communication, but not limitive of the scope of the subject invention.

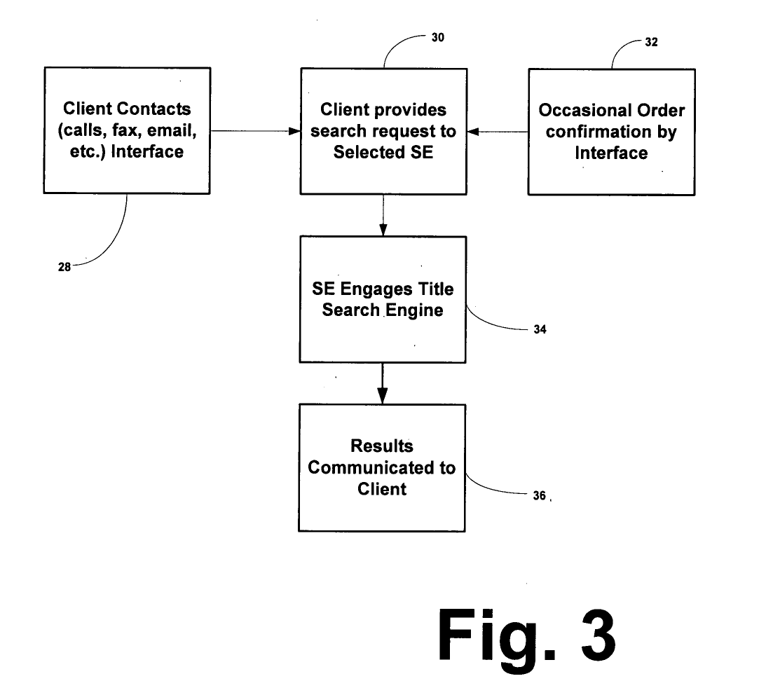

FIG. 3 shows an overall systems view of major components of the method and system of the subject invention, for clarification, but not for limiting purposes. In particular, client contacts (calls, fax, email, etc.) the interface via step 28. The client provides search requests to selected search engines via step 30 either directly, or under the preferred embodiment, via interface 4 (see FIG. 1). Occasionally, the order is confirmed by the interface via step 32, subject to the election of the client (who, at times, may require such confirmation in order to be assured that the request has been communicated and to receive an anticipated or actual date of delivery of the results) or by the polling function provided by the system as established hereinabove. After the searcher engages the title search via step 34 and the search is performed, the results are thereupon communicated back to the client via step 36.

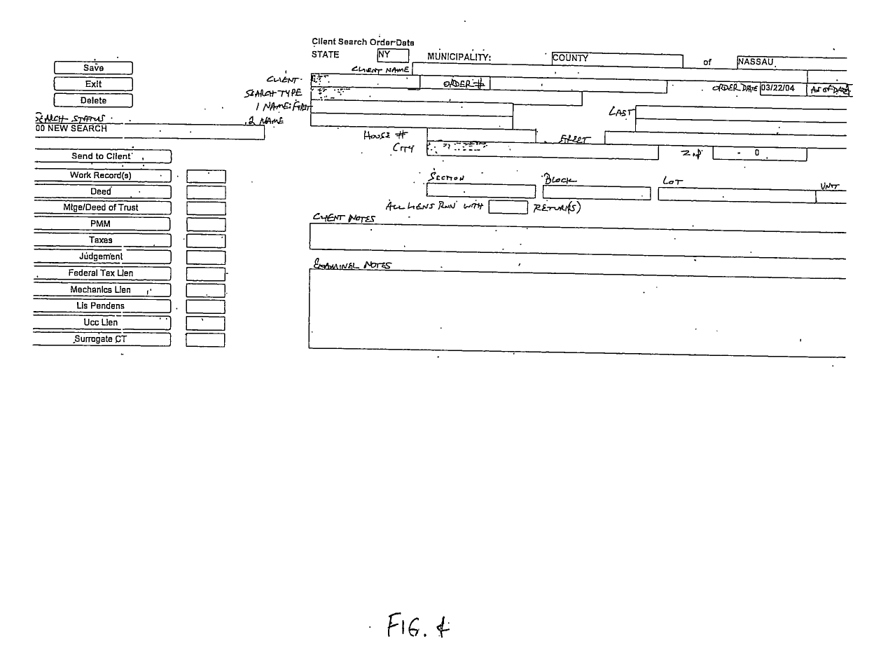

FIGS. 4 through 7 show actual screen captures of a preferred embodiment of the invention, showing various forms and fields of entry of information of the currently preferred software environment. It should be understood that the method and system of the invention is uniquely flexible in that it can is designed to rearrange, change, modify, add and delete as necessary, in accordance with the invention, to arrange for various differences that exist among jurisdictions as well various different needs that individual clients may require. Such flexibility enables theretofore unavailable modifications to enable capture of data from the plurality of different geographical locations and their inherent anomalies, in the manner in which real property information has been historically maintained.

In particular FIG. 4 sets forth the layout for receipt of a new order in accordance with a preferred embodiment of the subject invention. In particular, the fields include those for the state, municipality, county, client, search type, name, and, in this specific instance, the section, block, lot and unit number. It should be appreciated that this information will change depending upon the geographical location of the property and the mechanisms by which information is stored in those locations, without deviation from the spirit and intent of the invention which is adaptable to permit such field redesignations.

As shown in each of FIGS. 4 through 7, there are two sections, one for client notes and one for examiner notes. The former permits the searcher to indicate any special circumstances concerning that screen, while the examiner notes are viewable only by the examiner and permit the examiner to maintain any special information that may later be of value or concern. Indeed, critically in every screen in the preferred embodiment these two fields exist to permit free form addition of information relevant to that specific screen. The fields shown on the left side of FIG. 4 are self-explanatory, in relation to real property, and are completed if and when relevant to the search being performed. The total number of entries for each such item are listed in the box directly adjacent to each such item.

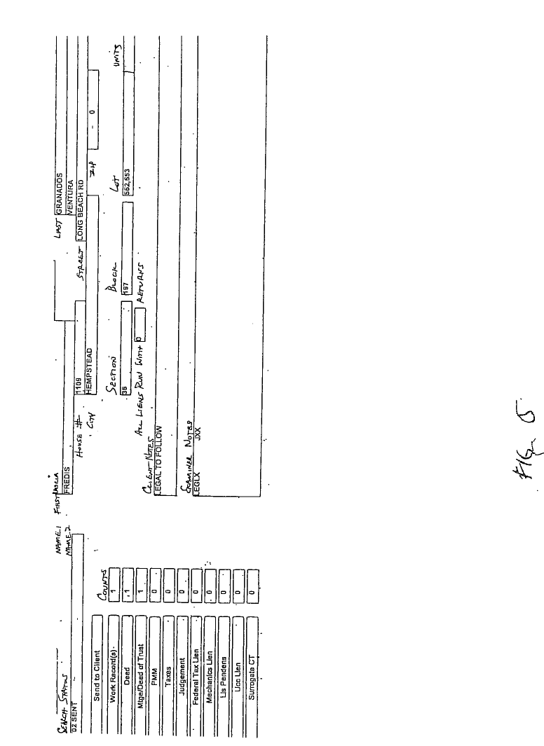

FIG. 5 shows FIG. 4 in completed format, indicating relevant information, as well as including the counts for the items listed on the left side of the screen, including, without limitation, deeds, mortgages and liens.

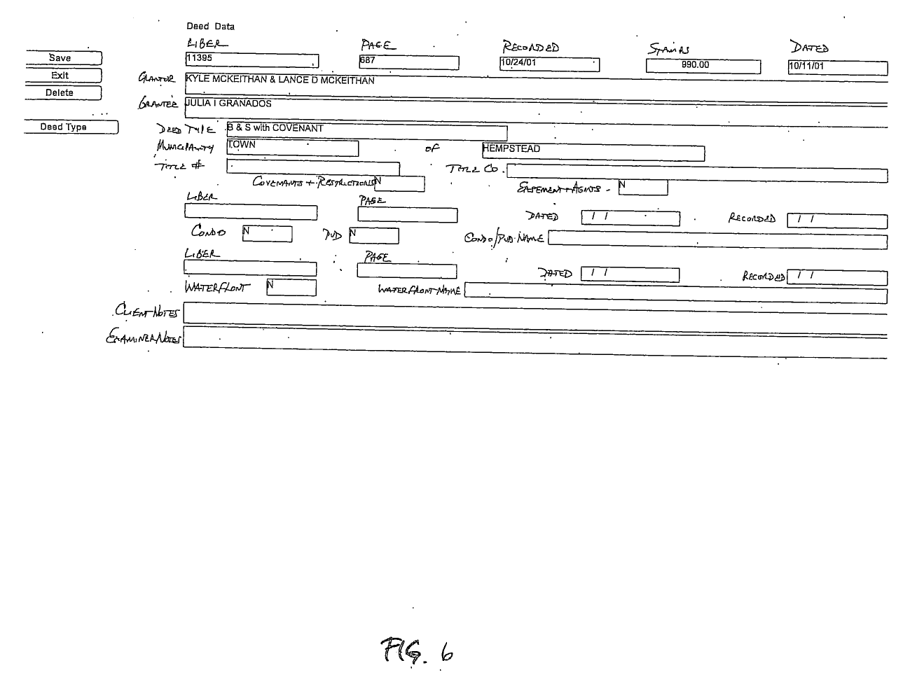

FIG. 6 shows a screen indicating deed information for a completed search with relevant fields completed in accordance with the specifics of the search being performed.

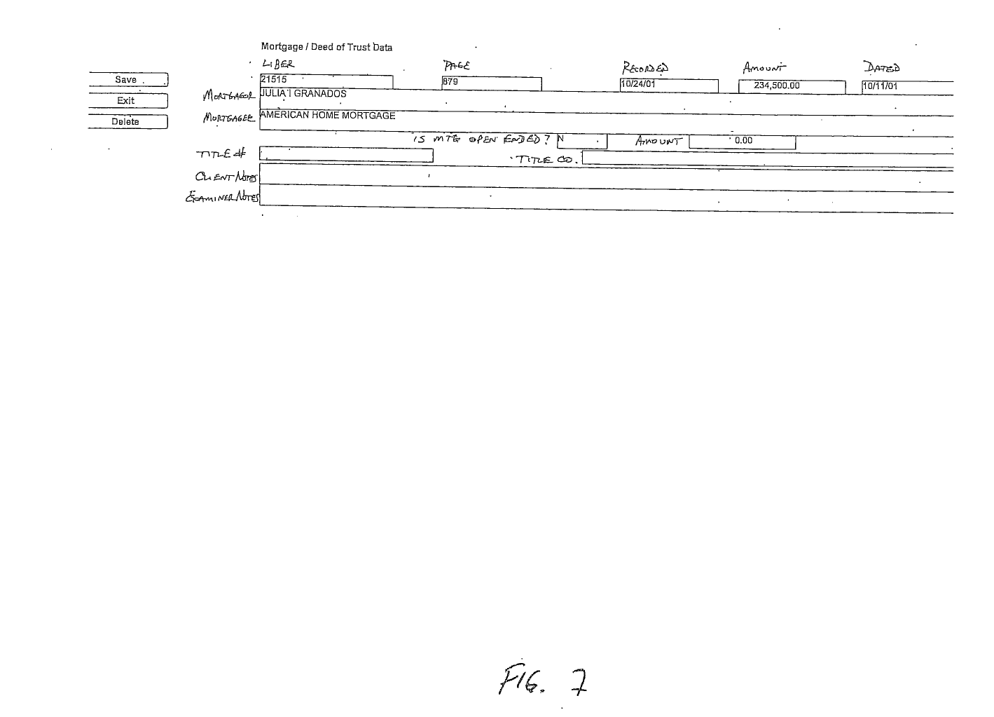

FIG. 7 shows a screen indicating mortgage information for a completed search, with relevant fields completed in accordance with the specifics of the search being performed.

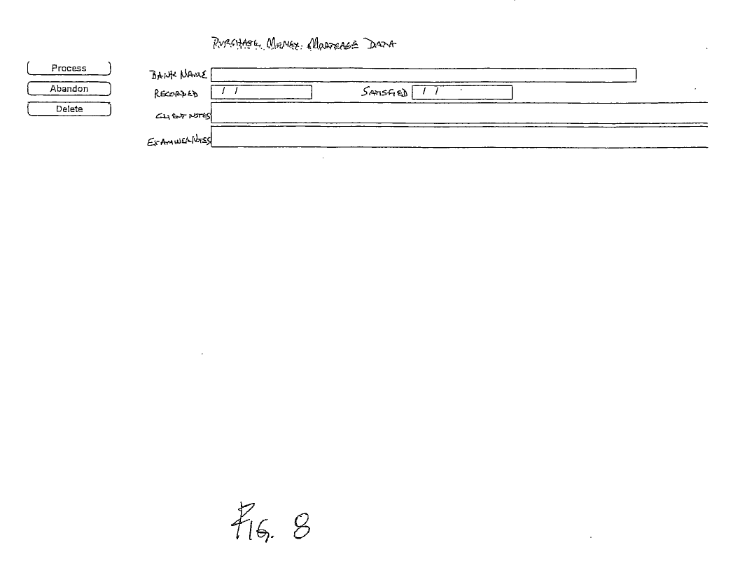

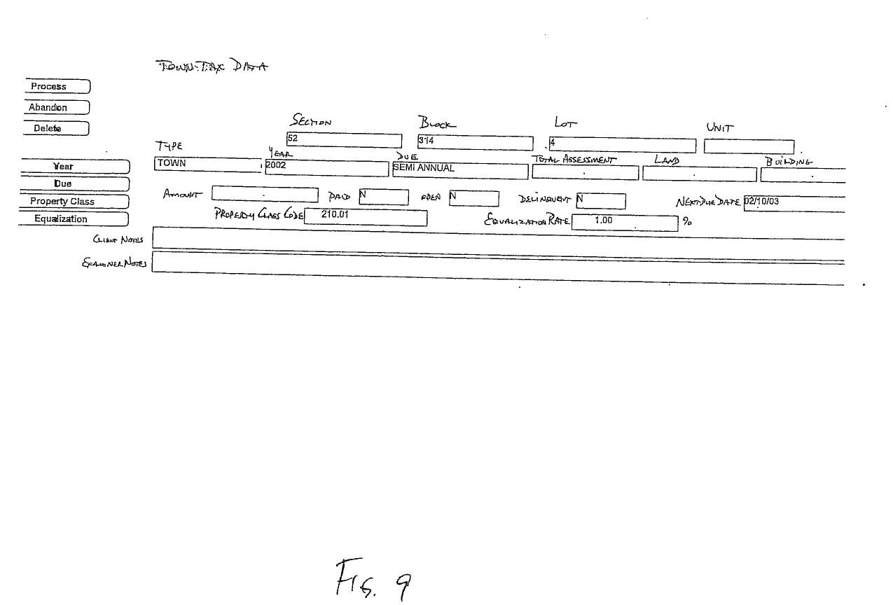

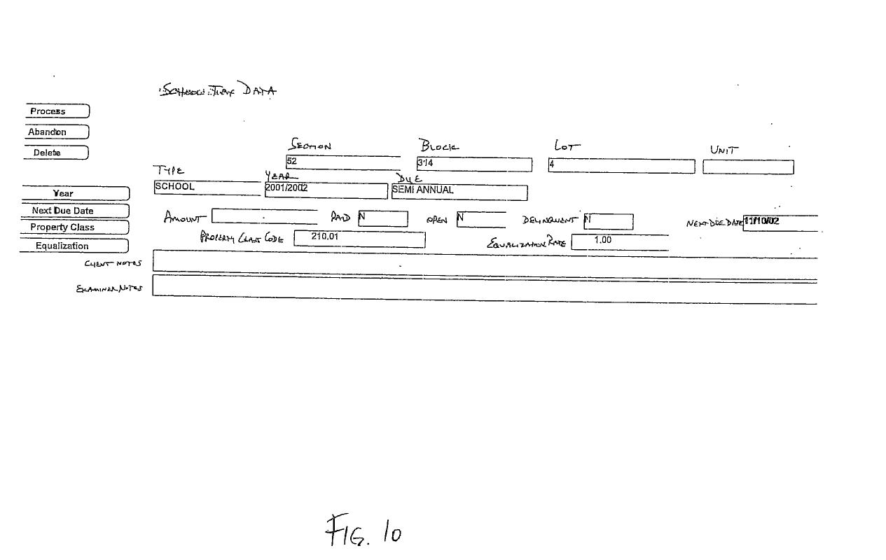

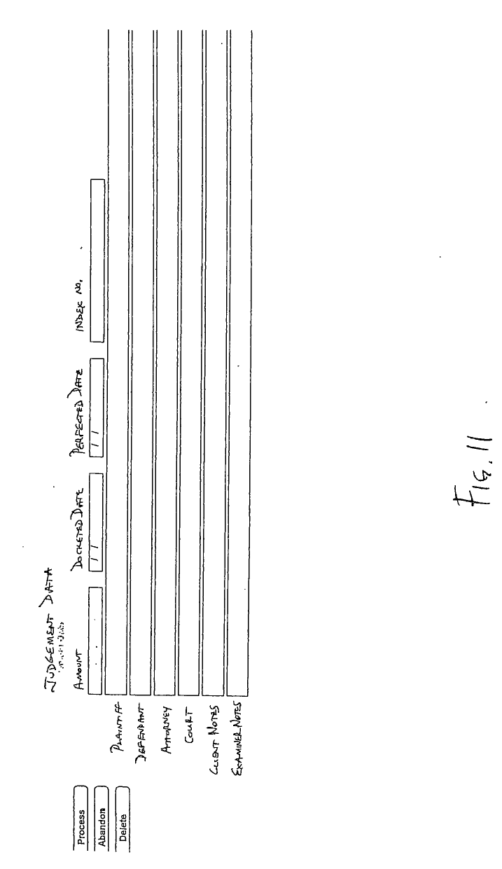

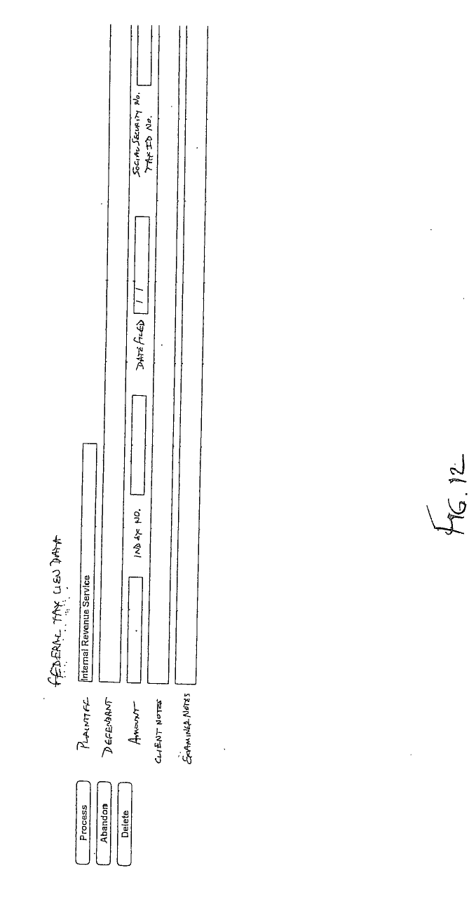

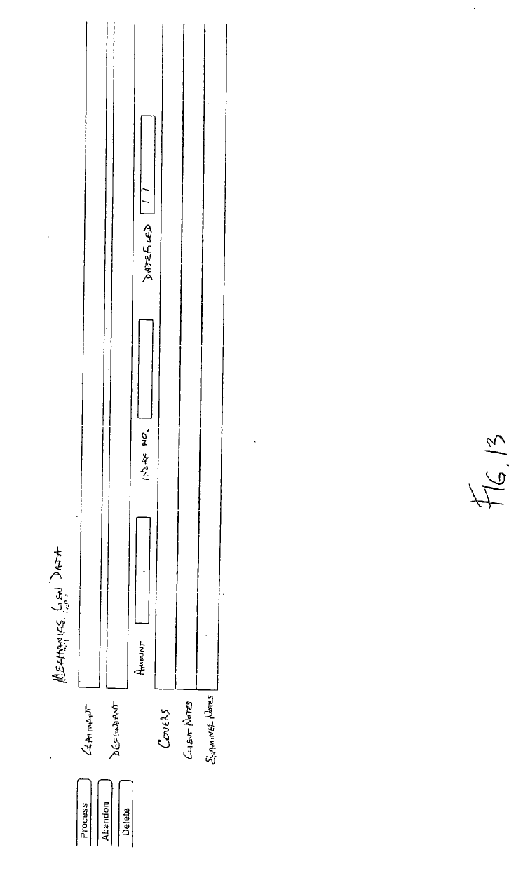

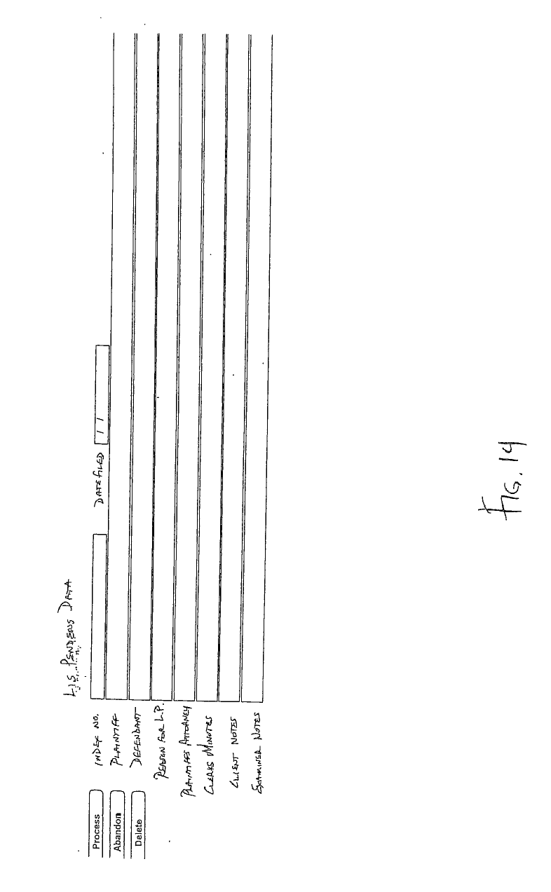

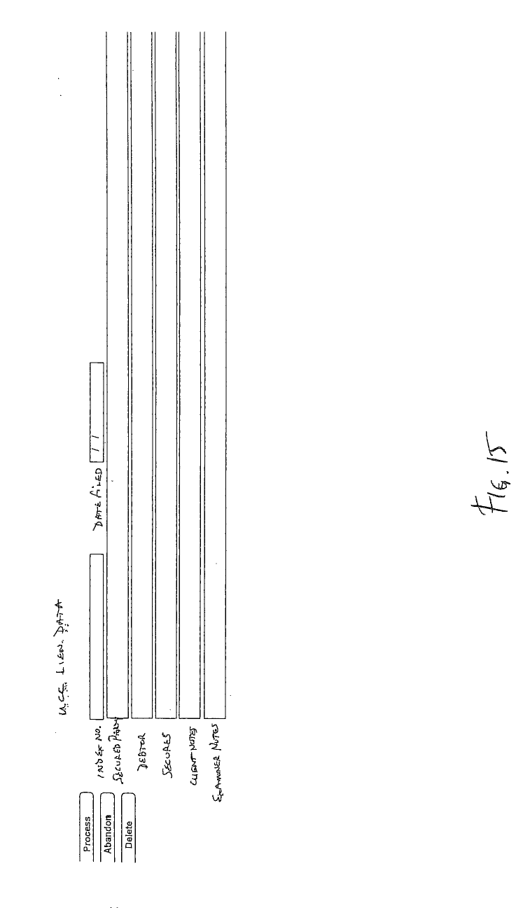

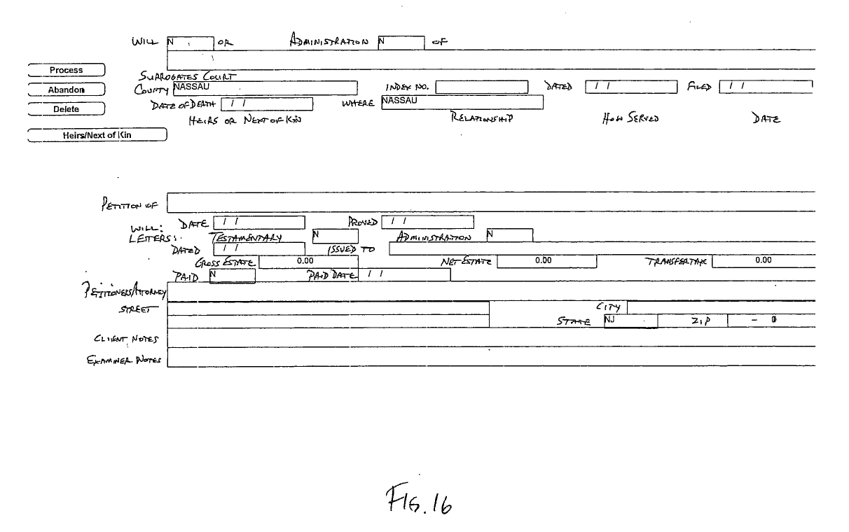

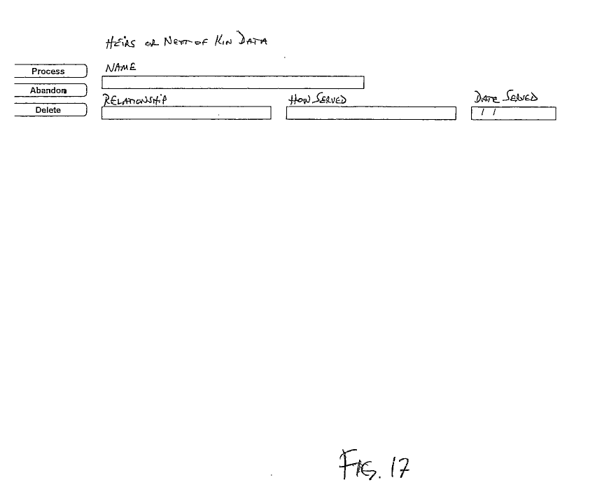

FIGS. 8 through 17 comprise screens containing fields for the capture of data, as set forth in their descriptions hereinabove, and as established on the figures themselves. One of ordinary skill in the art will appreciate that the flexibility of the screens inherent in the inventive system and method can be modified, altered, added to or subtracted from dependent upon variables including, e.g., geographically-specific information, without deviation from the spirit or intent of the invention as claimed.

It should further be appreciated and understood from one of ordinary skill in the art that the actual implementation, from a software perspective, is not specific to an operating system or application. Indeed, the final software application can be “web-centric” such that all information is downloaded via the Internet to a central storage location, and all data maintained there. Of course, there will still be some storage on the search engine, and the overall mechanisms to assure archival safety and accuracy of information, as provided by DB1 through 3, or their equivalents will be present to assure that documents cannot be modified, and hence authenticity can be maintained.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A system for automated title searching and reporting, comprising:
(a) at least one computer each having software, and at least one database;
(b) an interface for receiving instructions from at least one client setting forth desired title information for at least one piece of property and designating one of said at least one computer(s) for receipt thereof;
(c) means for communicating said desired title information to said designated computer;
(d) means for searching and gathering data concerning said desired title information;
(d) said designated computer, via said software, presenting one or more screens for interpolation of data concerning said desired title information;
(e) interpolation of said data into said one or more screens;
(f) storing said interpolated data on one of said at least one database(s); and
(g) transmitting said interpolated data to said at least one client.

2. The system of claim 1, wherein said at least one database includes a database that logs use of the system.

3. The system of claim 1, wherein said at least one database includes a database that archives data selected from the group consisting of data, interpolated data, and combinations thereof.

4. The system of claim 1, wherein said at least one database includes a database that archives said interpolated data for access by said at least one client.

5. The system of claim 1, wherein said interface has unlimited access to each of said at least one database.

6. The system of claim 1, wherein said computer having software further comprises means for scanning one or more documents for storage in, and retrieval from, said at least one database.

7. The system of claim 1, wherein said means for gathering data comprises access to computer-stored images of documents including, without limitation, images from a database located at an office, via an intranet, and via the Internet.

8. The system of claim 1, further comprising means for reporting the recordation of documents relating to title information.

9. The system of claim 1, wherein said computer and software include means for management of said data, and billing for the use of the system in the manner proscribed.

10. The system of claim 1, wherein said transmitting of interpolated data is performed by facsimile.

11. The system of claim 10, wherein said facsimile transmission is performed by way of said computer and said software.

12. The system of claim 10, wherein said facsimile transmission is performed by way of a facsimile device external to said computer and said software.

13. A method for automated title searching and reporting, comprising the steps of:
(a) receiving instructions from at least one client setting forth desired title information for at least one piece of property;
(b) communicating said instructions to at least one computer having software specifically configured with a multiplicity of screens for interpolation of data relating to title information;
(c) searching and gathering data concerning said desired title information;
(d) interpolating said data into said software and said screens to create interpolated data;
(e) storing said interpolated data; and
(f) communicating said interpolated data to said at least one client responsive said received instructions.

14. The method of claim 13, further comprising the step of receiving said instructions via an interface, wherein said interface determines which of said at least one computer is appropriate to perform the desired instructions.

15. The method of claim 13, wherein said searching and gathering of data includes data acquired from the group consisting of publicly stored data, intranet data, and Internet data.

16. The method of claim 15, wherein said storing of said interpolated data includes at least one database.

17. The method of claim 17, wherein said at least one database includes archival records.

18. The method of claim 17, wherein said at least one database record data showing the use of each of said at least one computer having software for the purposes of billing.

19. The method of claim 13, wherein said received instructions are for a determination of whether a document has been recorded, and said communication includes the determination and billing for such activity.

20. The method of claim 13, wherein said communication step is via facsimile.
